(19) United States
(12) Patent Application Publication
(10) Pub. No.: US 2023/0213998 A1
(43) Pub. Date: Jul. 6, 2023

(54) PREDICTION-BASED SYSTEM AND METHOD FOR OPTIMIZING ENERGY CONSUMPTION IN COMPUTING SYSTEMS

(71) Applicant: QUANTA CLOUD TECHNOLOGY INC., Taipei City (TW)

(72) Inventors: Pa HSUAN, Taipei City (TW); Tsung-Hung CHIANG, Taipei City (TW); Chia-Jui LEE, Taipei City (TW); Chia-Hsin HUANG, Taipei City (TW)

(21) Appl. No.: 17/568,667

(22) Filed: Jan. 4, 2022

(51) Int. Cl. G06F 1/324; G06F 1/3287; G06N 3/08

(52) U.S. Cl. CPC G06F 1/324; G06F 1/3287; G06N 3/08

(57) ABSTRACT

A system for dynamically scaling a service is configured to receive usage data of a computing system infrastructure. The usage data includes historical usage data and current usage data. The system is further configured to train a machine learning model using the historical usage data, such that the machine learning model receives, as input, the current usage data and provides, as output, a status of the computing system infrastructure. Based at least in part on the status of the computing system infrastructure, the system is further configured to change a configuration of the computing system infrastructure by adjusting a frequency of a central processing unit (CPU).

### TECHNICAL FIELD

The present disclosure relates generally to systems and methods for optimizing energy consumption of computing systems, and more specifically, pre-adjusting frequency of processors of the computing systems, based on prior usage of the computing systems (i.e., based on data volume).

### BACKGROUND

Computing systems (e.g., desktop computers, blade servers, rack-mount servers, etc.) are employed in large numbers in various applications. Computing systems have been instrumental in developing and advancing computationally intensive applications, for example, developing artificial intelligence (AI) and modeling of complex systems using high performance computing. High performance systems have been used in understanding complex systems like gene recognition in deoxyribonucleic acid (DNA) base pairs, modeling communication systems in three dimensions, solving intractable problems using heuristics, etc.

Although advancements in computing systems have enabled understanding complex systems, low energy efficiency is a problem associated with these advanced computing systems. A large number of computational tasks require computer components like central processing units (CPUs), graphical processing units (GPUs), field programmable gate arrays (FPGAs), etc., to consume energy in order to complete the computational tasks. In some cases, a higher energy or power consumption by these components amounts to a gain in computational performance. Although the gain in computational performance is sometimes desired, being able to achieve an acceptable performance at a reasonable energy consumption is also desirable due to heat generation by computer components, energy required to cool computing systems, and overall environmental impact of dedicating generated power from generators and power plants to power datacenters, supercomputers, etc. Thus, the present disclosure is directed at solving problems related to energy efficiency of computing systems.

### SUMMARY

Some implementations of the present disclosure provide a system for dynamically scaling a computer based service. The system includes a non-transitory computer-readable medium storing computer-executable instructions thereon such that when the instructions are executed, the system is configured to receive usage data of a computing system infrastructure. The usage data includes historical usage data and current usage data. The system is further configured to train a machine learning model using the historical usage data such that the machine learning model receives as input, the current usage data, and provides as output, a status of the computing system infrastructure. The system is further configured to determine, using the machine learning model and the current usage data, that the status of the computing system infrastructure is subpar. The system is further configured to change a configuration of the computing system infrastructure by adjusting CPU frequency on the computing system infrastructure.

In an embodiment, the machine learning model is trained using an artificial recurrent neural network. In an embodiment, the current usage data includes current physical processor usage of the computing system infrastructure, current physical storage usage of the computing infrastructure, current physical memory usage of the computing infrastructure, current physical network resource usage of the computing infrastructure, current virtual processor usage of the computing system infrastructure, current virtual storage usage of the computing infrastructure, current virtual memory usage of the computing infrastructure, or current virtual network resource usage of the computing infrastructure. In an embodiment, the historical usage data includes historical physical processor usage of the computing system infrastructure, historical physical storage usage of the computing infrastructure, historical physical memory usage of the computing infrastructure, current physical network resource usage of the computing infrastructure, historical virtual processor usage of the computing system infrastructure, historical virtual storage usage of the computing infrastructure, historical virtual memory usage of the computing infrastructure, or historical virtual network resource usage of the computing infrastructure. In an embodiment, the scaled service is a network based application. In an embodiment, the computing devices include a plurality of physical machines. One or more virtual machines, one or more containers, and/or one or more virtual network function components are provided on the physical machines. In an embodiment, the frequency of the CPU is positively correlated with a predicted usage. In an implementation, a network-based application is running on the computing system infrastructure when the CPU frequency is adjusted.

Some implementations of the present disclosure provide a method for dynamically adjusting CPU frequency. The method is performed by a server, and the method includes receiving, by the server, usage data of a computing system infrastructure that includes computing devices providing services. The usage data includes historical usage data and current usage data. The server trains a machine learning model using the historical usage data such that the machine learning model receives as input, the current usage data, and provides as output, a status of the computing system infrastructure. The server determines, using the machine learning model and the current usage data, that the status of the computing system infrastructure is subpar. The server changes a configuration of the computing system infrastructure by pre-adjusting CPU frequency on the computing system infrastructure.

In an embodiment, the machine learning model is trained using an artificial recurrent neural network. In an embodiment, the current usage data includes current physical processor usage of the computing system infrastructure, current physical storage usage of the computing infrastructure, current physical memory usage of the computing infrastructure, current physical network resource usage of the computing infrastructure, current virtual processor usage of the computing system infrastructure, current virtual storage usage of the computing infrastructure, current virtual memory usage of the computing infrastructure, or current virtual network resource usage of the computing infrastructure. In an embodiment, the historical usage data includes historical physical processor usage of the computing system infrastructure, historical physical storage usage of the computing infrastructure, historical physical memory usage of the computing infrastructure, current physical network resource usage of the computing infrastructure, historical virtual processor usage of the computing system infrastructure, historical virtual storage usage of the computing infrastructure, historical virtual memory usage of the computing infrastructure, or historical virtual network resource usage of the computing infrastructure. In an embodiment, a network-based application is running on the computing system infrastructure when the CPU is adjusted. In an embodiment, the computing devices include a plurality of physical machines. In an embodiment, the frequency of the CPU is positively correlated with a predicted usage.

Some implementations of the present disclosure provide a non-transitory computer-readable medium for dynamically scaling a service in a computing system. The non-transitory computer-readable medium storing computer-executable instructions for performing: receiving, by a telemetry subsystem of the computing system, usage data of a computing system infrastructure including computing devices providing services, the usage data including historical usage data and current usage data. The instructions further perform training, by a data analytics engine of the computing system, a machine learning model using the historical usage data such that the machine learning model receives, as input, the current usage data and provides, as output, a status of the computing system infrastructure. The instructions further perform determining, by the data analytics engine of the computing system, using the machine learning model and the current usage data, that the status of the computing system infrastructure is subpar. The instructions further perform changing, by a NFV manager of the computing system, a configuration of an NFV infrastructure of the computing system by adjusting a frequency of a central processing unit (CPU).

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of embodiments together with reference to the accompanying drawings.

FIG. 1 illustrates a system architecture with a decision system, according to some implementations of the present disclosure.

FIG. 2 illustrates an example network functions virtualization manager of the system architecture of FIG. 1, according to some implementations of the present disclosure.

FIG. 3 illustrates components of a computing system, according to some implementations of the present disclosure.

FIG. 4 is a flow diagram illustrating steps for configuring a computing infrastructure, according to some implementations of the present disclosure.

FIG. 5 illustrates example results based on at least some implementations of the present disclosure.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

Computing systems with advanced operating systems provide task monitoring for processes running on the computing systems. These operating systems provide a basic level of control of the power efficiency of the computing systems by adjusting frequency of the computing systems. Frequency adjustment can include increasing or reducing processor speed, memory read/write speed, etc. Although advanced operating systems can perform some of these adjustments, most operating system strategies involve staying in a high performance state, without performing the adjustments, in order to be able to handle new tasks that may arise. Staying in a high performance state usually entails a higher energy consumption. Therefore, an energy consumption and performance service level agreement (SLA) may not be met or guaranteed for some performance-sensitive programs, such as AI model training and Data Plane Development Kit (DPDK) network processing programs. Also, even with a frequency adjustment implemented, conventional computing systems cannot readily adjust energy consumption in proportion to workload of the computing system.

Computing systems usually run programs, applications, and/or services. Resources are usually allocated to the programs, applications, and services, thus placing a capacity on memory usage, CPU usage, storage usage, network bandwidth usage, etc. From the point of view of service capacity, the service capacity can be easily scaled in (or out) according to current CPU or memory usage so that additional resources can be deallocated from (or allocated to) the service. A management software application typically monitors the service and resources, and automatically controls scaling of the service. For a stateful service, launching a new service entity is a time-consuming task, and the newly launched service entity may not be immediately prepared to accept requests from a client. Launching a new service can take the order of seconds to minutes, depending on application, hence processing by the computing systems can be detrimentally affected. In an example, when launching a virtual machine for an application, the virtual machine needs to be first deployed, then launched, then an operating system run on the virtual machine before the application is run. Each of these steps in launching the virtual machine can take several tens of seconds. Therefore, the total period can exceed one minute, which fails to meet the requirement of real-time orchestration. Also, for some connection-oriented services, such as games, virtual private networks (VPNs), and 5G connections, frequent scaling in (or out) introduces a difficulty of managing sessions of these connection-oriented services. For example, frequent scaling can lead to service interruptions, which translates to a decreased quality of service due to service reconnections and service handovers associated with scaling operations.

As such, some implementations of the present disclosure provide a system that monitors performance of a computing system. The system collects and stores data related to performance statistics of the computing system, which can include operational data pertaining to application behavior. By analyzing the performance statistics data, the system can determine a relationship between performance of the computing system and power consumption of the computing system. The system can use the determined relationship to establish a baseline for the computing system being monitored. The baseline will include the typical power requirements for the system over the course of a day, a week, or other time periods.

Embodiments of the present disclosure utilize machine learning algorithms to analyze the performance statistics data in order to develop models for making future performance predictions. Incremental training techniques can be used to adapt to variation in client or user behaviors (e.g., variations in applications run by a user, variation in activities performed by the user in each application being run, etc.). The pre-trained (or developed) models obtained by the system can be used to predict values (e.g., values related to service requirements) for a given subsequent time period. Based on these predicted values, the computing system can be pre-configured by pre-adjusting CPU frequency for the running applications. In an implementation, pre-adjusting CPU frequency involves independently adjusting CPU frequency for specified cores of the CPU. The specified cores of the CPU are pre-allocated, and the CPU frequency of the specified cores are pre-adjusted. For example, given a CPU with a total of 20 cores, when an application requires 8 cores, the 8 cores that will run the application are pre-allocated, and the CPU frequency for each of the 8 cores is pre-adjusted. The rest of the 12 cores can be allocated for running other applications, having settings or CPU frequency configuration that is different from the 8 cores.) Therefore, some implementations of the present disclosure can meet real-time orchestration by pre-adjusting the CPU frequency to timely respond to required compute capability. Energy savings is accomplished by adjusting the CPU frequency rather than pre-launching a virtual machine. Accordingly, power efficiency and service availability can be improved, thereby reducing failure issues associated with adjusting to meet SLAs. The service can be a network-based application, for example, a virtual private network, a 5G connection, a game application, etc.

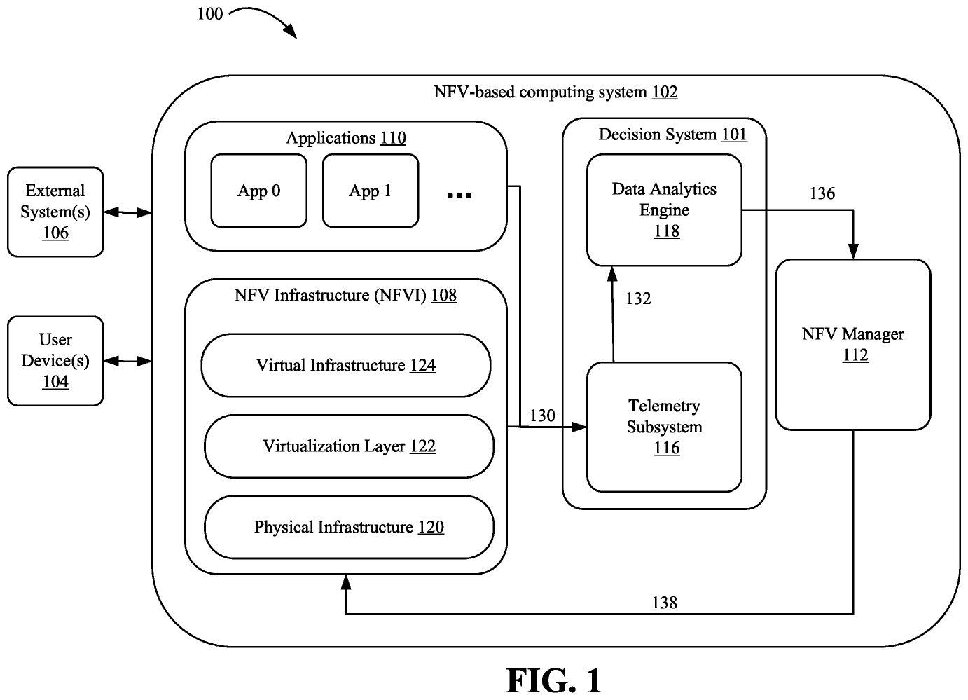

FIG. 1 illustrates a system architecture 100 including a decision system 101, according to some implementations of the present disclosure. The system architecture 100 can be based on network functions virtualization (NFV). In NFV, network services needed to support an infrastructure are delivered independent from underlying hardware by decoupling network functions from proprietary purpose-built hardware appliances. For example, NFV allows an enterprise to implement a router, firewall, and domain name service, without the need for proprietary purpose-built hardware appliances. NFV enables more seamless performance for cloud computing, data center networking, etc.

The system architecture 100 includes an NFV-based computing system 102, one or more user devices 104, and one or more external systems 106. The user devices 104 can include laptop computers, desktop computers, tablet computers, smartphones, personal digital assistants (PDA), smart watches, fitness trackers, internet of things (IoT) devices, or any other consumer electronic device that can communicate with a cloud computing system. The external systems 106 can include servers, desktop computers, laptop computers, or any other consumer electronic device used by an institutional entity. The institutional entity can include an enterprise, a doctor's office, a research facility, a university, etc. The NFV-based computing system 102 provides services to the user devices 104 and/or the external systems 106. For example, the user devices 104 and/or the external systems 106 can rely on the NFV-based computing system 102 to provide a network address translation (NAT) service, a firewall service, an encryption service, a domain name service (DNS), a router service, a deep packet inspection (DPI) service, a broadband remote access server (BRAS) service, a load balancer service, a virtual private network (VPN) service, etc. The user devices 104 and/or the external systems 106 can also rely on the NFV-based computing system 102 to run cloud-based applications. For example, the user devices 104 can offload application computing to the NFV-based computing system 102, since the NFV-based computing system 102 has more computing resources than the user devices 104.

The NFV-based computing system 102 includes an NFV infrastructure 108, the decision system 101, and an NFV manager 112. The NFV infrastructure 108 includes physical and virtual infrastructure for running one or more applications 110. The NFV manager 112 implements policy on how the NFV infrastructure 108 deploys computational, storage, and network resources. The decision system 101 accumulates performance statistics data to predict future resource usage of the NFV infrastructure 108. In some implementations, the performance statistics data are obtained from application and/or system log files. System log files can include services and processes running when a virtual machine is created, issues related to graphical user interface (GUI) services, user sign-in and sign-out frequency, failed sign-in attempts, changes made to kernels, applications and/or programs installed, applications and/or programs removed, etc. Application log files can include changes made to programs, crash events of programs, error codes associated with crash events, resource usage by program, resource usage by tasks being performed by programs, etc. In some implementations, the performance statistics data is obtained in real-time such that the decision system 101 samples the real-time data as being received. For example, the decision system 101 can sample fan speed of a specific computing device at specific or variable intervals, processor usage of the specific computing device at specific or variable intervals, energy consumption of the specific computing device at specific or variable intervals, etc. In some implementations, the performance statistics data is obtained by introspecting network throughput of virtual network functions and/or frequency of CPUs, thus obtaining real-time throughput values and virtual machine statistics. In some implementations, a program running on a virtual machine can periodically call an application programming interface in a Linux kernel through a library to obtain the performance statistics data pertaining to the network.

The NFV infrastructure 108 includes a physical infrastructure 120. The physical infrastructure 120 is hardware infrastructure that includes servers or other computing devices configured in a network. The physical infrastructure 120 includes a number of processors or CPUs, storage disks, memory devices, and network interfaces. The physical infrastructure 120 describes the hardware resources available for the NFV-based computing system 102.

The NFV infrastructure 108 includes a virtualization layer 122 and a virtual infrastructure 124. The virtualization layer 122 includes a hypervisor and virtual machine monitor. The hypervisor is a computer firmware that creates one or more virtual machines within the virtual infrastructure 124. The virtual infrastructure 124 can host a number of virtual machines and/or virtual network functions. The virtual infrastructure 124 can be described in a similar manner as the physical infrastructure 120. That is, the virtual infrastructure 124 can have virtual processor resources, virtual storage resources, virtual memory resources, and virtual network resources. The virtualization layer 122 creates each of the virtual machines in the virtual infrastructure 124. The virtual infrastructure 124 is merely a rearranging of the physical infrastructure 120 in virtual space. For example, the physical infrastructure 120 includes two servers, and the virtualization layer 122 is used to create three virtual machines. The user devices 104 that use the NFV-based computing system 102 to run a program can be presented an option of choosing one of the three virtual machines to run the program. Thus, the virtual infrastructure 124 need not include a same number of virtual machines as physical machines in the physical infrastructure 120.

The applications 110 run on the virtual infrastructure 124. Each of the applications 110 (e.g., App 0, App 1, App 2, and the like) does not have to run on the same virtual machine. For example, App 0 and App 2 can run on virtual machine #1, and App 1 can run on virtual machine #2. The applications 110 can be programs, applications, services, network functions, etc. The applications 110 can be requested by the user devices 104 and/or the external systems 106. Since the applications 110 run on virtual machines, and virtual machines are spun-up having maximum resource capacities, sometimes the applications 110 can require more resources than the virtual machines can provide. For example, App 0 running on virtual machine #1 may run slowly because App 0 is a storage intensive application requiring up 200 GB of storage while virtual machine #1 has a maximum storage capacity of 180 GB of storage. The lack of free space on virtual machine #1 can adversely affect the speed at which App 0 is running or can lead to App 0 crashing. In these instances, to prevent App 0 from crashing or to improve performance of App 0, a virtual machine #3 with storage space of 250 GB can be spun up, and a clone of App 0 can be run on virtual machine #3. Once the clone App 0 is ready, then App 0 can be closed on virtual machine #1, and clone App 0 continues the work that App 0 was previously performing on virtual machine #3. This process of spinning up new virtual machine resources and handing off application work is an example of scaling out an application. The NFV manager 112 is responsible for deciding when to scale out an application.

The decision system 101 includes a telemetry subsystem 116 and a data analytics engine 118. The telemetry subsystem 116 collects data 130 from the NFV infrastructure 108. The data 130 collected from the NFV infrastructure 108 includes date, time, server, service, CPU, throughput, etc. In some implementations, the format for the data 130 can be <20200917.235959> <5GCore> <server01 UPF> <throughput:100Gb>, where <20200917.235959> indicates the date and time, <5GCore> indicates the CPU, <server01 UPF> indicates a specific server and a specific service, and <throughput:100Gb> indicates network throughput. The telemetry subsystem 116 formats the collected data and sends the formatted data 132 to the data analytics engine 118 for data inferencing and modeling.

The data analytics engine 118 develops a usage model based on the data collected by the telemetry subsystem 116. The data analytics engine 118 uses the usage model to make predictions 136 on future uses of the NFV infrastructure 108. The predictions 136 are sent to the NFV manager 112 so that the NFV manager configures the NFV infrastructure 108 using the predictions 136. In an example, the predictions 136 can be formatted as <20200917.235959> <5g Core> <server 01 UPF> <1 hour> <throughput:200Gb>. The NFV manager 112 provides the NFV infrastructure 108 with NFV configuration settings 138. The NFV configuration settings 138 can include service orchestration, overlay network topology, and policies.

The data analytics engine 118 can train several kinds of models to predict status of an application, a program, a service, and/or the NFV infrastructure 108. In some implementations, the trained models are stored periodically in a storage device associated with the data analytics engine 118. The stored models can be retrieved by the data analytics engine 118 prior to making predictions or inferences based on the stored models. For example, the data analytics engine 118 can make predictions on future network traffic of the NFV infrastructure 108. The data analytics engine 118 can retrieve a stored model related to the traffic growth trends, to make the prediction on future network traffic at a designated future time.

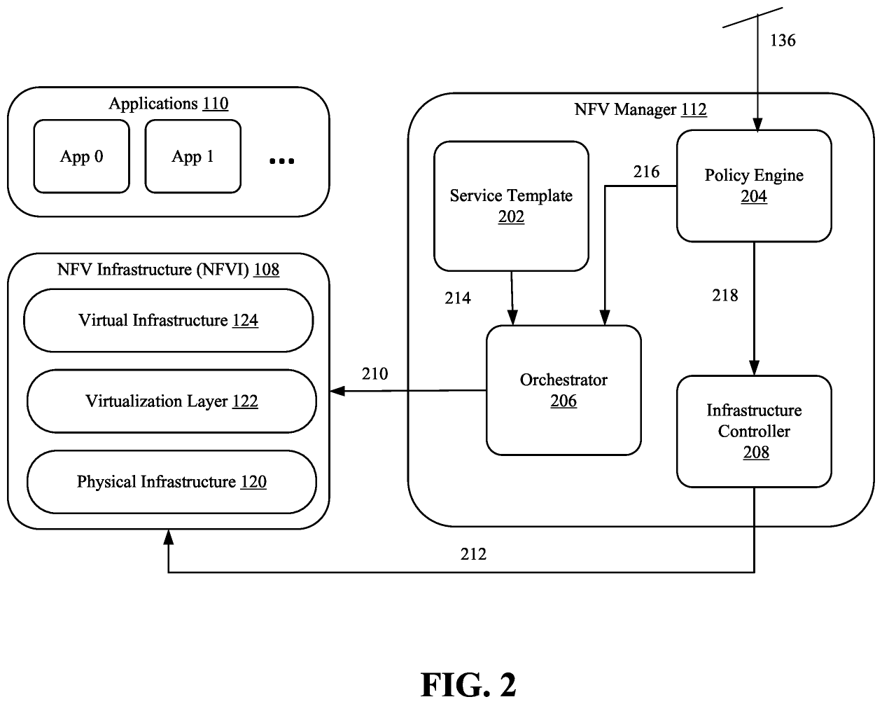

FIG. 2 illustrates components of the NFV manager 112 of FIG. 1, according to some implementations of the present disclosure. The NFV manager 112 includes a service template 202, a policy engine 204, an orchestrator 206, and an infrastructure controller 208. The predictions 136 from the data analytics engine 118 (in FIG. 1) are received at the policy engine 204. In some implementations, the predictions 136 include one or more events, e.g., a spike in virtual machine demand at a certain time of day. These spikes can lead to the predictions 136 sometimes including increasing (or decreasing) CPU frequency relative to a current CPU frequency level. In some implementations, the predictions 136 generally regard throughput as having a regular pattern such as the working days and weekend in a company, and the data analytics engine 118 can use the trained usage model to fulfill the requirements. The policy engine 204 of the NFV manager 112 can determine a predefined action for dealing with the received events. For example, if the NFV infrastructure 108 is expected to tackle huge number of upcoming packets, a received event indicates that a service currently running fails to timely handle these packets, the policy engine 204 can select a predefined scale-up action to adjust CPU frequency for the service. The predictions 136 can include a future status of the NFV infrastructure and/or the applications 110 determined by the data analytics engine 118. The policy engine 204 can use the received future status to determine an action based on predetermined rules. In an example, the predetermined rules can include a rule indicating that (a) a 100 Gb throughput needs one virtual machine instance running at a highest CPU frequency (e.g., normalized to 1 CPU frequency), and (b) a 610 Gb throughput needs seven virtual machine instances with a last service instance running at around 90% of the CPU frequency to balance the service workloads and effectively tackle packets.

If the policy engine 204 determines that a configuration of the NFV infrastructure and/or the applications 110 should be changed, then the policy engine 204 delivers configuration actions 218, for undertaking the change, to the infrastructure controller 208. The infrastructure controller 208 includes applications and hardware configuration abstraction application programming interfaces (APIs). When the infrastructure controller 208 receives the configuration actions 218 from the policy engine 204, the infrastructure controller 208 translates the received configuration actions 218 to related commands 212 and sends the commands 212 to the NFV infrastructure and/or the applications 110. In an example, the received configuration actions 218 include “scale up to 2.1 GHz”, and the infrastructure controller 208 translates the received configuration actions 218 to the related commands 212 which include “Set_CPU_freq CPU 2.0”. A CPU's performance can be characterized as a function of CPU frequency (see Table 1 for an example based on Intel 6252N processor). The infrastructure controller 208 translates the received configuration actions 218 to real Linux or OpenStack commands. In some implementations, the received configuration actions 218 is translated to the related commands 212 using a lookup table (e.g., “scale up” or “scale down” can point to “Set_CPU_freq” command in the lookup table). The lookup table can be modified according to the result of the usage model determined by the data analytics engine 118. The infrastructure controller 208 can send the commands 212 for configuring the NFV infrastructure and/or the applications 110 through Redfish API, RESTConf protocol, NETCONF protocol, or other similar protocols.

TABLE 1
Intel 6252N CPU performance as a function of CPU
frequency, given a packet size of 1228 bytes

| CPU Frequency (GHz) | Performance (Gbps) |
|---|---|
| 1.0 | 8.13 |
| 1.1 | 8.909 |
| 1.2 | 9.68 |
| 1.3 | 10.42 |
| 1.4 | 11.23 |
| 1.5 | 11.94 |
| 1.6 | 12.59 |
| 1.7 | 13.46 |
| 1.8 | 14.20 |
| 1.9 | 15.10 |
| 2.0 | 16.04 |
| 2.1 | 16.92 |

If the policy engine 204 determines that a service orchestration or control should be performed, the policy engine 204 delivers orchestration actions 216 to the orchestrator 206. The orchestration actions 216 include a service type and service configuration. The service type includes a virtual machine instance scale and CPU frequency adjustment. The service configuration includes the service running on a number of virtual machine instances and configuration of the CPU of those virtual machine instances. For example, the service configuration can include running the service on 7 virtual machine instances, and the instances running on CPU resources with 2.1 GHz frequency. The orchestrator 206 searches the service template 202, based on the service type and the service configuration, and receives service configuration 214 from the service template 202. The orchestrator 206 provides signals 210 to the NFV infrastructure 108. The signals instruct the NFV infrastructure 108 to launch or terminate the service designated for control. The signals 210 and the commands 212 of FIG. 2 when combined indicate the NFV configuration settings 138 of FIG. 1.

In an example, the orchestration actions 216 define a number of frequency levels (e.g., 5 frequency levels), with each level corresponding to a specific traffic loading. Specific traffic loading can include, for example, 8 Gbps, 10 Gbps, 14 Gbps, etc. The orchestration actions 216 are different from the configuration actions 218 in that the configuration actions 218 can further define specific configurations of the specific orchestration actions 216. For example, the orchestration actions 216 defining a number of frequency levels as 5 frequency levels can refer to CPU levels of 1.2 GHz, 1.6 GHz, 1.8 GHz, 2 GHz, and 2.1 GHz, and the configuration actions 216 are specific actions to set up a specific CPU level (e.g., the actions required to set up the 1.8 GHz CPU level).

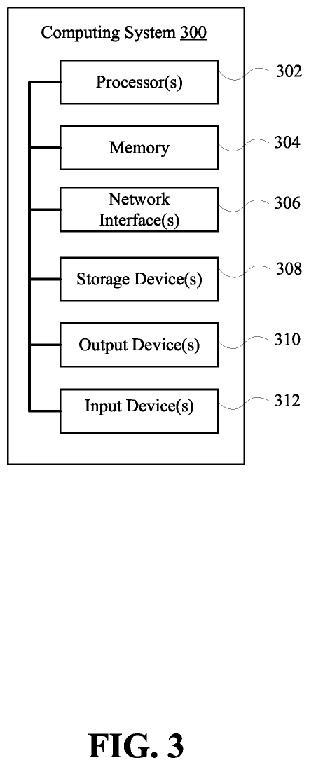

FIG. 3 illustrates a block diagram of a computing system 300, according to some implementations of the present disclosure. The computing system 300 can be an example of the user devices 104, a server or other device in the external systems 106, and/or a server or other hardware in the NFV-based computing system 102 of FIG. 1. The NFV-based computing system 102 can include multiple computing systems 300 in a network for implementing the NFV infrastructure 108, the decision system 101, the data analytics engine 118, the telemetry subsystem 116, the NFV manager 112, the service template 202, the policy engine 204, the orchestrator 206, the infrastructure controller 208, or any other identifiable engine or module in FIGS. 1 and 2.

In FIG. 3, the computing system 300 includes a processor 302, a memory 304, a network interface 306, a storage device 308, an output device 310, and/or an input device 312. Each component of the computing system 300 is interconnected physically, communicatively, and/or operatively for inter-component communications in order to realize functionality ascribed to the user devices 104, the external systems 106, and/or the NFV-based computing system 102 of FIG. 1. The components of the computing system 300 can be controlled by software running on an operating system of the computing system 300. To simplify the discussion, the singular form will be used for all components identified in FIG. 3 when appropriate, but the use of the singular does not limit the discussion to only one of each component. For example, multiple processors may implement functionality attributed to the processor 302.

The processor 302 implements functions and/or processes instructions for execution. For example, the processor 302 executes instructions stored in the memory 304 or instructions stored on the storage device 308. In some implementations, instructions stored on the storage device 308 are transferred to the memory 304 for execution at the processor 302. The processor 302 can include multiple physical cores on a single chip. The processor 302 can support virtualization such that a total number of cores of the processor 302 is greater than the total number of physical cores present on the processor 302. Memory 304, which may be a non-transitory, computer-readable storage medium, is configured to store information within the computing system 300 during operation. In some implementations, the memory 304 includes a temporary memory that does not retain information stored when computing system 300 is turned off. Examples of such temporary memory include volatile memories such as random access memories (RAM), dynamic random access memories (DRAM), and static random access memories (SRAM). The memory 304 also maintains program instructions for execution by the processor 302. The memory 304 can serve as a conduit for other internal or external storage devices, coupled to the computing system 300, to gain access to the processor 302.

The storage device 308 includes one or more non-transient computer-readable storage media. The storage device 308 stores larger amounts of information than the memory 304, and in some instances, is configured for long-term storage of information. In some implementations, the storage device 308 includes non-volatile storage elements. Non-limiting examples of non-volatile storage elements include floppy discs, flash memories, magnetic hard discs, optical discs, solid state drives, or forms of electrically programmable memories (EPROM) or electrically erasable and programmable (EEPROM) memories.

The network interface 306 is used to communicate with external devices, computers, servers, etc. The computing system 300 may include multiple network interfaces 306 to facilitate communication via multiple types of networks. The network interface 306 may include network interface cards (e.g., Ethernet cards, optical transceivers, radio frequency transceivers, or any other type of device that can send and receive information). Some examples of the network interface 306 include communication hardware compatible with Wi-Fi, 3G, 4G, Long-Term Evolution (LTE), 5G, Bluetooth®, WiMAX, etc.

The computing system 300 may include one or more output devices 310. The output device 310 provides an output to a user of the computing system 300 using tactile, audio, and/or video information. Examples of the output device 310 include a display screen (cathode ray tube (CRT) display, liquid crystal display (LCD) display, LCD/light emitting diode (LED) display, organic LED display, etc.), a sound card, a video graphics adapter card, speakers, magnetics, or any other type of device that may generate an output intelligible to a user. The computing system 300 may also include one or more input devices 312. The input device 312 receives input from the user of the computing system 300 or the environment where the computing system 300 resides. In some implementations, the input device 312 includes devices that facilitate interaction, between the computing system 300 and the environment where the computing system 300 resides, through tactile, audio, and/or video feedback. The input device 312 can include a presence-sensitive screen or a touch-sensitive screen, a mouse, a keyboard, a video camera, microphone, a voice responsive system, or any other type of input device.

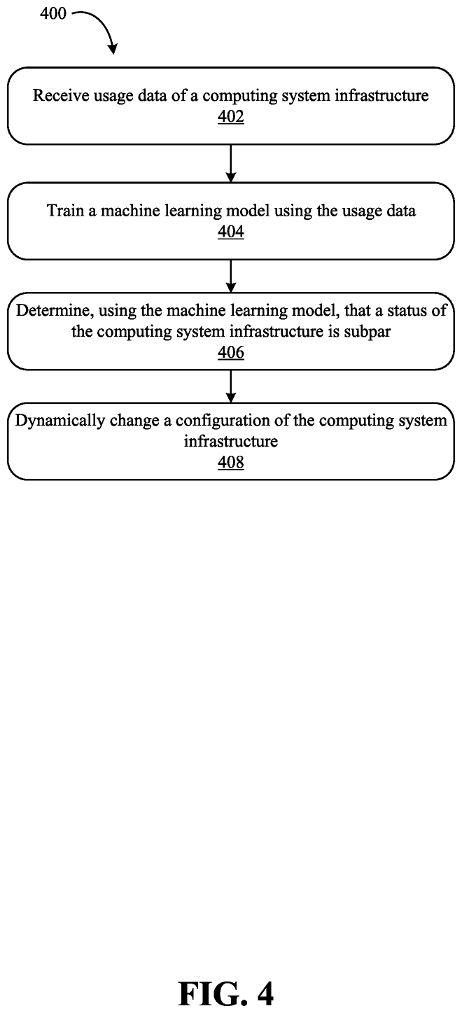

FIG. 4 is a flow diagram of a process 400 for configuring a computing infrastructure, according to some implementations of the present disclosure. The process 400 can be performed by components of the NFV-based computing system 102 of FIG. 1. At step 402, the telemetry subsystem 116 (FIG. 1) receives usage data pertaining to the NFV infrastructure 108 (FIG. 1). The usage data includes resource usage of the NFV infrastructure 108. The usage data can be timestamped such that each time entry includes an associated entry for used physical resources, available physical resources, used virtual resources, available virtual resources, number of virtual machines running, guest operating systems running on each of the virtual machines, a number of clients connected (e.g., the user devices 104 and/or the external systems 106), a number of applications 110 (FIG. 1) running, monitored data pertaining to the physical infrastructure 120 (FIG. 1), monitored data pertaining to the virtualization layer 122 (FIG. 1), monitored data pertaining to the virtual infrastructure 124 (FIG. 1), monitored data pertaining to the applications 110 (FIG. 1), etc. In an example, the monitored data for the different components identified can include CPU percentage use over a period of time, CPU average loading over a period of time, memory metrics, network interface card metrics, intelligent platform management interface (IPMI) metrics, power management unit (PMU) metrics, hard disk drive metrics, switch metrics, pooled peripheral component interconnect express (PCIe) metrics, etc.

The usage data can be stored as a comma-separated values file or can be stored in a spreadsheet or as database entries. In an example, the usage data includes system wait times associated with one or more CPUs of the NFV Infrastructure 108, user wait times associated with the one or more CPUs of the NFV Infrastructure 108, short term loading of the one or more CPUs, mid term loading of the one or more CPUs, long term loading of the one or more CPUs, number of instructions per CPU clock cycle, local CPU memory bandwidth, used memory measured in bytes, free memory measured in bytes, percent of memory used for buffer, percent of memory used for cache, total memory used, total free space, number of packets received and/or dropped by one or more network interface cards, packet errors by the one or more network interface cards, number of packets sent and/or dropped by the one or more network interface cards, CPU temperature, memory temperature, power supply voltages, memory voltages, CPU voltages, network interface card temperatures, fan status, etc.

Since the usage data is timestamped, some of the usage data can be classified as historical usage data and the rest can be classified as current usage data. Examples of historical usage data include any data that is over one week old, any data that is over two weeks old, any data that is over one day old, any data that is over two days old, any data that is over a year old, etc. In some implementations, historical data is any data that is over ten seconds old, a minute old, ten minutes old, an hour old, a few hours old, etc. Current data can include data that is within 10 seconds.

At step 404, the data analytics engine 118 (FIG. 1) trains a machine learning model using the usage data collected by the telemetry subsystem 116 (FIG. 1). The data analytics engine 118 can train different machine learning algorithms based on information that can be gleaned from the collected usage data. The historical usage data can be used for training the machine learning model such that the machine learning model can receive, as input, the current usage data and provide, as output, a status of the NFV infrastructure 108. For example, historical usage data that spans a two-year timespan can be used for training the machine learning model.

In some implementations, training the machine learning model includes training an artificial recurrent neural network (e.g., a long short-term memory (LSTM) artificial recurrent neural network). The development platform of Keras framework with Python is used during training.

In some implementations, training the machine learning model includes training an artificial neural network. The artificial neural network can be a multi-layer perceptron neural network. The multi-layer perceptron neural network can include an input layer, one or more hidden layers, and an output layer. Each of the input layer, the one or more hidden layers, and the output layer includes a set of nodes or neurons. The input layer is connected to the one or more hidden layers, which is connected to the output layer. Each of the connections between sets of nodes of the different layers has an associated weight. Training the multi-layer perceptron neural network involves determining the associated weight for each of the connections. A gradient descent algorithm or linear regression algorithm can be used to determine the weights. Each node of the input layer and the one or more hidden layers includes a non-linear activation function, such as a sigmoid or a soft-max function. The output layer provides one or more decision outputs. Once the multi-layer perceptron neural network is trained, usage data provided at the input layer results in one or more decision outputs at the output layer. The one or more decision outputs can be alerts or predictions based on the usage data.

At step 406, the data analytics engine 118 can determine, using the trained machine learning model, that a status of the NFV infrastructure 108 is subpar. In some implementations, the data analytics engine 118 can determine that network traffic exceeds a traffic threshold (e.g., exceeds 1 Gbps, 10 Gbps, etc.) for a specific CPU speed. In some implementations, the data analytics engine 118 can determine that network traffic is below a traffic threshold for a specific CPU speed.

At step 408, the NFV manager 112 (FIG. 1) dynamically changes a configuration of the NFV infrastructure 108. In some implementations, changing the configuration includes scaling in (or out) a service. In some implementations, changing the configuration includes scaling in (or out) an application. In some implementations, changing the configuration includes terminating an application 110 or service. In some implementations, changing the configuration includes reducing CPU speed based on network traffic being below a traffic threshold. In some implementations, changing the configuration includes increasing CPU speed based on network traffic exceeding a traffic threshold.

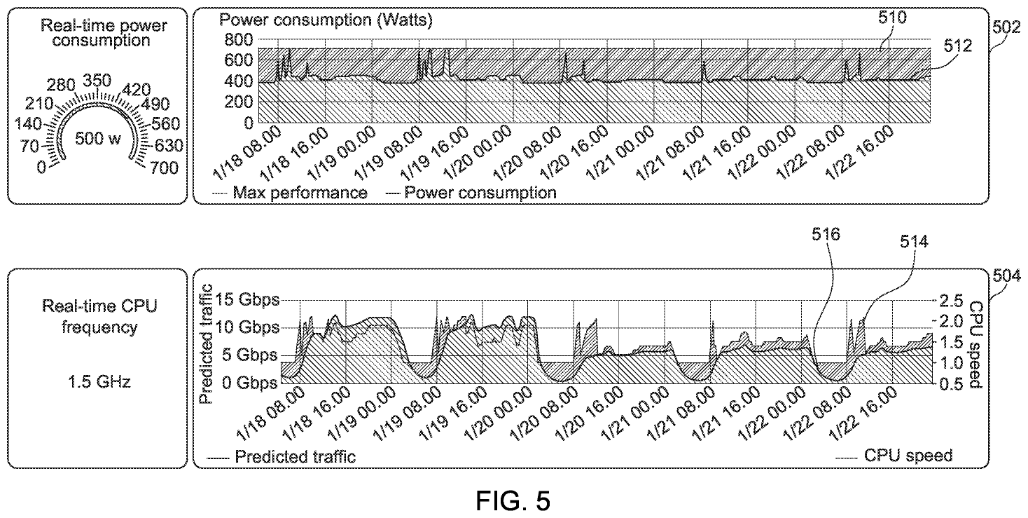

FIG. 5 illustrates example results of power consumption over time for different system configurations. In FIG. 5, power consumption graph 502 pertains to a computing system's power consumption over time when optimized by adjusting CPU frequency, and system configuration graph 504 pertains to a computing system that is optimized to handle on-demand traffic In FIG. 5, the graph 502 shows power consumption at maximum performance 510, indicating that power consumption remains at the maximum power consumption without any adjustment to the CPU frequency. The graph 502 also shows power consumption under CPU frequency adjustment 512. When CPU frequency is adjusted, the power consumption fluctuates, indicating energy savings over time when compared to the power consumption at maximum performance 510. CPU frequency in the graph 502 is adjusted based on the predicted traffic volume 516 in graph 504. The predicted traffic volume 516 is measured in gigabits per second (Gbps) in the graph 504. CPU frequency 514 is indicated in the graph 504 in gigahertz (GHz), and the fluctuating CPU frequency 514 of the graph 504 yields the power and energy savings indicated in the graph 502. The predicted data traffic and CPU frequency are positively correlated. As the data traffic increases, the CPU frequency is relatively increased. In an example, Table 1 can be used to adjust frequency based on predicted data traffic. The power consumption under CPU frequency adjustment 512 and the CPU frequency 514 show positive correlation as well, indicating adjusting CPU frequency can effectively reflect the energy saving of power consumption. The difference between the power consumption at maximum performance 510 and the power consumption under CPU frequency adjustment 512 is the power savings achieved.

Embodiments of the present disclosure provide a decision system for fine-tuning infrastructure parameters or scaling applications or services through prediction results from the decision system. Embodiments of the present disclosure include programmable policy rules to determine adjustment actions. Embodiments of the present disclosure can use the collected data to adjust performance metrics of computing infrastructure such that power efficiency of the computing infrastructure is reduced.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A system for dynamically scaling a service, the system including a non-transitory computer-readable medium storing computer-executable instructions thereon such that when the instructions are executed, the system is configured to:
receive usage data of a computing system infrastructure including computing devices providing services, the usage data including historical usage data and current usage data;
train a machine learning model using the historical usage data such that the machine learning model receives, as input, the current usage data and provides, as output, a status of the computing system infrastructure;
determine, using the machine learning model and the current usage data, that the status of the computing system infrastructure is subpar; and
change a configuration of the computing system infrastructure by adjusting a frequency of a central processing unit (CPU).

2. The system of claim 1, wherein the machine learning model is trained using an artificial recurrent neural network.

3. The system of claim 1, wherein the current usage data includes current physical processor usage of the computing system infrastructure, current physical storage usage of the computing system infrastructure, current physical memory usage of the computing system infrastructure, current physical network resource usage of the computing system infrastructure, current virtual processor usage of the computing system infrastructure, current virtual storage usage of the computing system infrastructure, current virtual memory usage of the computing system infrastructure, or current virtual network resource usage of the computing system infrastructure.

4. The system of claim 1, wherein the historical usage data includes historical physical processor usage of the computing system infrastructure, historical physical storage usage of the computing system infrastructure, historical physical memory usage of the computing system infrastructure, current physical network resource usage of the computing system infrastructure, historical virtual processor usage of the computing system infrastructure, historical virtual storage usage of the computing system infrastructure, historical virtual memory usage of the computing system infrastructure, or historical virtual network resource usage of the computing system infrastructure.

5. The system of claim 1, wherein a network-based application is running on the computing system infrastructure when the CPU frequency is adjusted.

6. The system of claim 1, wherein the computing devices include a plurality of physical machines, and one or more virtual machines, one or more containers, and/or one or more virtual network function components are provided on the physical machines.

7. The system of claim 1, wherein the frequency of the CPU is positively correlated with a predicted usage.

8. A method for dynamically scaling a service, the method being performed by a server, and the method comprising:
receiving, by the server, usage data of a computing system infrastructure including computing devices providing services, the usage data including historical usage data and current usage data;
training, by the server, a machine learning model using the historical usage data such that the machine learning model receives, as input, the current usage data and provides, as output, a status of the computing system infrastructure;
determining, by the server, using the machine learning model and the current usage data, that the status of the computing system infrastructure is subpar; and
changing, by the server, a configuration of the computing system infrastructure by adjusting a frequency of a central processing unit (CPU).

9. The method of claim 8, wherein the machine learning model is trained using an artificial recurrent neural network.

10. The method of claim 8, wherein the current usage data includes current physical processor usage of the computing system infrastructure, current physical storage usage of the computing system infrastructure, current physical memory usage of the computing system infrastructure, current physical network resource usage of the computing system infrastructure, current virtual processor usage of the computing system infrastructure, current virtual storage usage of the computing system infrastructure, current virtual memory usage of the computing system infrastructure, or current virtual network resource usage of the computing system infrastructure.

11. The method of claim 8, wherein the historical usage data includes historical physical processor usage of the computing system infrastructure, historical physical storage usage of the computing system infrastructure, historical physical memory usage of the computing system infrastructure, current physical network resource usage of the computing system infrastructure, historical virtual processor usage of the computing system infrastructure, historical virtual storage usage of the computing system infrastructure, historical virtual memory usage of the computing system infrastructure, or historical virtual network resource usage of the computing system infrastructure.

12. The method of claim 8, wherein a network-based application is running on the computing system infrastructure when the CPU frequency is adjusted.

13. The method of claim 8, wherein the computing devices include a plurality of physical machines, and one or more virtual machines are provided on the physical machines.

14. The method of claim 8, wherein the frequency of the CPU is positively correlated with a predicted usage.

15. A non-transitory computer-readable medium for dynamically scaling a service in a computing system, the non-transitory computer-readable medium storing computer-executable instructions for performing:
receiving, by a telemetry subsystem of the computing system, usage data of a computing system infrastructure including computing devices providing services, the usage data including historical usage data and current usage data;
training, by a data analytics engine of the computing system, a machine learning model using the historical usage data such that the machine learning model receives, as input, the current usage data and provides, as output, a status of the computing system infrastructure;
determining, by the data analytics engine of the computing system, using the machine learning model and the current usage data, that the status of the computing system infrastructure is subpar; and
changing, by a NFV manager of the computing system, a configuration of an NFV infrastructure of the computing system by adjusting a frequency of a central processing unit (CPU).
